(19) United States
(12) Patent Application Publication
(10) Pub. No.: US 2004/0244247 A1
(43) Pub. Date: Dec. 9, 2004

(54) Photo luminescent and light source combination exit sign

(76) Inventor: Charles Bolta, Ft. Collins, CO (US)

Correspondence Address: Emery L. Tracy, P.O. Box 1518, Boulder, CO, 80306-1518, US

(21) Appl. No.: 10/861,762

(22) Filed: Jun. 4, 2004

Related U.S. Application Data
(60) Provisional application No. 60/475,983, filed on Jun. 5, 2003.

(51) Int. Cl. G09F 13/04; G09F 13/20

(52) U.S. Cl. 40/570; 40/542

(57) ABSTRACT

A sign for indicating an egress from a room is provided. The sign comprises a photo-luminescent material and at least one light source adjacent the photo-luminescent material for charging the photo-luminescent material.

The present application is a continuation of pending provisional patent application Ser. No. 60/475,983, filed on Jun. 5, 2003, entitled “Photo Luminescent and Light Emitting Diode Combination Exit Signage Powered by Low Voltage Telephone and Security Systems DC Source”.

### BACKGROUND OF THE INVENTION

1. Field of the Invention

This invention relates generally to an exit sign and, more particularly, the invention relates to a lighted exit sign which uses a photo luminescent and light source combination to illuminate the exit sign.

2. Description of the Prior Art

Exit signs are commonly found in essentially all commercial buildings. In general, the purpose of an exit sign is to direct a person's attention to the location of a suitable building exit. To achieve this function, it is known to provide exit signs along corridors in order to lead one to an exit, as well as directly adjacent the exit itself. Typically, such exit signs are mounted on surrounding walls or suspended from a ceiling. In any case, exit signs mark the way for people leaving a building.

In the event of an emergency, such as a building fire, exit signs can play a crucial role in enabling people to safely leave the building in a timely manner. Typically, an audible fire alarm is sounded as an initial indicator of the presence for possibility of a fire. In addition, strobe lights are also often used as visual indicators in such emergency situations, especially in large scale commercial buildings such as hotels, hospitals, convention centers, large office buildings and the like. Furthermore, it is known in the art to provide auxiliary lighting heads on the housing of an exit sign in order to illuminate the area leading to and around the exit.

Frequently, exit signs are illuminated so that they will be visible in the dark in the event that power is interrupted to the building's lighting system. Most of these exit signs are required to exhibit a specific amount of illumination and, oftentimes, must have an emergency backup power source to provide emergency illumination for a specified period of time during periods when utility power to the building is discontinued, thereby facilitating egress of persons from the building. The illuminated exit signs normally have an auxiliary power source separate and apart from the main power source feeding the building's lights. In fact, this is mandated by code in most jurisdictions.

Unfortunately, during extreme conditions, the emergency backup power source is compromised or otherwise ceases to function. This leads to non-illumination of the exit signs and a potentially dangerous situation for the occupants of the building. It is believed that an occupant failing to see an exit sign could lead to confusion of the occupants and delay or inhibit the occupants from leaving the building.

Accordingly, there exists a need for a photo luminescent and light source combination exit sign which illuminates the exit sign regardless of whether the emergency backup power source has been compromised. Additionally, a need exists for a photo luminescent and light emitting diode (L.E.D.) combination exit sign which provides ample illumination for viewing by the occupants of a building during emergency conditions. Furthermore, there exists a need for a photo luminescent and light emitting diode (L.E.D.) combination exit sign which extend the battery-backup power supply with the after glow properties of the photo-luminescent crystals.

### SUMMARY

The present invention is a sign for indicating an egress from a room is provided. The sign comprises a photo-luminescent material and at least one light source adjacent the photo-luminescent material for charging the photo-luminescent material.

In addition, the present invention includes an exit sign. The exit sign comprises a backing material and photo-luminescent material applied to the backing material. Light means charge the photo-luminescent material.

The present invention further includes a method for indicating an exit from a room. The method comprises applying a photo-luminescent material and charging the photo-luminescent material.

### BRIEF DESCRIPTION OF THE DRAWINGS

FIG. 1 is a front elevational view illustrating a photo luminescent and light emitting diode combination exit signage, constructed in accordance with the present invention;

FIG. 2 is a front elevational view illustrating another embodiment of the photo luminescent and light emitting diode combination exit signage, constructed in accordance with the present invention; and

FIG. 3 is a schematic view illustrating an AEP low voltage lighting system wiring, constructed in accordance with the present invention, for powering the photo luminescent and light emitting diode combination exit signage.

### DETAILED DESCRIPTION OF THE PREFERRED EMBODIMENTS

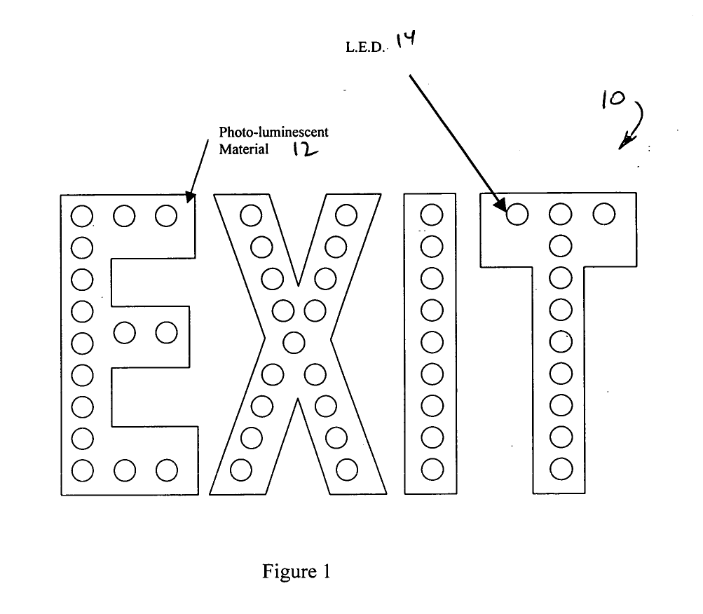

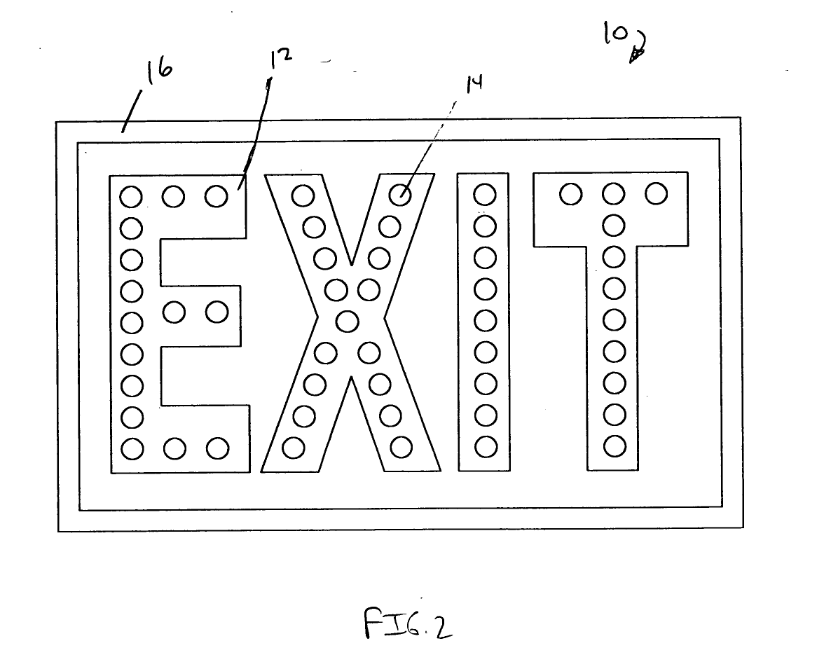

As illustrated in FIGS. 1 and 2, the present invention is a photo luminescent and light emitting diode combination exit sign, indicated generally at 10, powered by low voltage telephone and security systems DC source. Photo luminescent paint or other material 12 is used to mark the letters of the exit sign. Illuminating the sign from the rear, side, inside and front with Light Emitting Diodes (L.E.D) 14 or any other light source allows the exit sign 10 to be powered from low voltage sources such as telephone circuits and security systems. The unit can also be powered from conventional AC circuits as well.

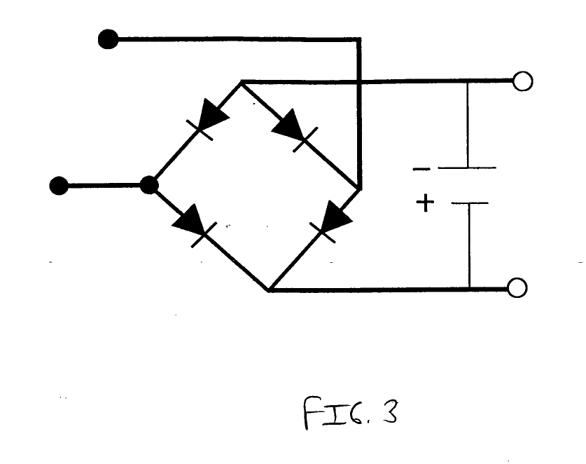

FIG. 3 is a schematic illustrating an AEP low voltage lighting system wiring which can be used to power the exit sign 10 of the present invention. Transformer wires can be connected without regard to polarity as the diode-bridge will automatically route power to the correct terminals called Negative and Positive. All diodes are similar and selected for the voltage for the input transformer and the current load, connected to Negative and positive. Each diode will consume approximately 0.5 volts so that loss must be considered when specifying the transformer. For example, IN4048 is sufficient for 1 amp at 50 volts DC. The fuse is connected in one of the transformer secondary wires and selected for 1.25 times the typical current as measured for the load connected at output terminals Positive and Negative.

In an embodiment of the exit sign 10 of the present invention, the photo-luminescent material 12 in the form of letters spelling EXIT, for example, are charged from ambient light as well as supercharged due to the closeness of the L.E.D. emitters 14 that are also on continuously until needed in a lost power condition. The L.E.D. emitters 14 or any other light source can be located either behind, to the side, or in the front of the photo-luminescent material 12 to charge the photo-luminescent material 14 so as to glow after any battery backup systems have been exhausted.

FIG. 1 illustrates the EXIT letters painted with photo-luminescent paint that is constantly being charged by the L.E.D. emitters 14. It should be noted that the photo-luminescent material 12 can be arranged to form any word or symbol, as desired.

To form the photo-luminescent material 12, photo-luminescent crystal powders are dissolved in solution and or put into plastics so as to be painted in the shape of the EXIT or other lettering of the signage. The L.E.D. emitters 14 are positioned to shine on the back, front, or from the side on the EXIT lettering. Power for the exit sign 10 preferably comes from low voltage phone, security, or transformers to power the L.E.D. emitters 14. Conventional 120 VAC with a step-down transformer could be used as well up to and including hardwiring of the exit sign 10. The L.E.D. emitters 14 are preferably located in either the front, rear, or side positions to charge the photo-luminescent material 12 to a higher state than could be achieved in ambient lighting found in most corridors. Power receptacles for the exit sign 10 of the present invention are of the telephony field known as the RJ 11 and RJ44 connectors for ease of installation. In the side L.E.D. emitter embodiment, the front plate of the exit sign 10 can be angled so as to be visible from the sides to increase the angle of incidence for the observer. As illustrated in FIG. 2, reflective tape 16 can be added about the periphery of the exit sign 10 similar to firemen suits for aiding visibility. Translucent plastics with photo-luminescent crystals in the plastics are arranged so that light inside the exit sign 10 would charge the crystals.

In sum, the present invention is a photo-luminescent exit sign 10 powered by L.E.D. emitters 14 or other lighting source so as to charge the photo-luminescent crystals to a higher level than ambient lighting. An integrated power system can be supplied from telephony equipment that is already power backed up by battery systems remote to the location as well as an internal battery in the exit sign 10. Power can also be supplied from security systems, telephony, or conventional 120 VAC. The L.E.D. emitters 14 can illuminate from the rear, front, or side to charge the photo-luminescent material 12. Combination of reflective material 16 outline on the EXIT area and photo-luminescent afterglow produce a dual extended redundancy of the exit sign 10 visibility beyond exhausted batteries. In addition, when charged by the L.E.D. emitters 14 or other light source, the photo-luminescent exit sign 10 of the present invention has sufficient brightness to at least partially illuminate a room acting as an emergency egress light during darkness or emergency.

The L.E.D. emitters 14 combined with photo-luminescent crystals 12 for the exit sign 10 produce a sign that extends the battery-backup power supply with the after glow properties of the photo-luminescent crystals 12. These photo-luminescent crystals 12 are charged to a higher level by the L.E.D. emitters 14 than can be achieved with ambient lighting. The intended embodiment is to be powered from battery backed-up telephony equipment, security systems or conventional 120 VAC power.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A sign for indicating an egress from a room, the sign comprising:
a photo-luminescent material; and
at least one light source adjacent the photo-luminescent material for charging the photo-luminescent material.

2. The sign of claim 1 wherein the light source is a light emitting diode (L.E.D.) emitter.

3. The sign of claim 2 wherein L.E.D. emitters emit light from the rear, front, or side to charge the photo-luminescent material.

4. The sign of claim 1 wherein the photo-luminescent material is a photo-luminescent paint.

5. The sign of claim 1 and further comprising:
an integrated power system for powering the light source selected from the group consisting of telephony equipment, security systems, and 120 VAC.

6. The sign of claim 1 wherein the sign is angled for viewing from the side.

7. The sign of claim 1 and further comprising:
a reflective material.

8. The sign of claim 1 wherein the photo-luminescent material is arranged to spell the word EXIT.

9. The sign of claim 1 wherein the photo-luminescent has sufficient brightness to at least partially illuminate a room acting as an emergency egress light during darkness or emergency.

10. An exit sign, the exit sign comprising:
a backing material;
photo-luminescent material applied to the backing material; and
light means for charging the photo-luminescent material.

11. The exit sign of claim 10 and further comprising:
a reflective material about a periphery of the backing material.

12. The exit sign of claim 10 wherein the photo-luminescent material is applied to the backing material to form the word EXIT.

13. The exit sign of claim 10 wherein the light means are at least one light emitting diode (L.E.D.).

14. The exit sign of claim 13 wherein the L.E.D. emitters emit light in a direction selected from the group consisting of rear, front, and side.

15. The exit sign of claim 10 wherein the photo-luminescent exit material has sufficient brightness to at least partially illuminate a room.

16. A method for indicating an exit from a room, the method comprising:
applying a photo-luminescent material; and
charging the photo-luminescent material.

17. The method of claim 16 and further comprising:
applying the photo-luminescent material to form the word EXIT.

18. The method of claim 16 and further comprising:
charging the photo-luminescent material with at least one light emitting diode (L.E.D.) emitter.

19. The method of claim 18 and further comprising:
emitting light from the L.E.D. emitters in a direction selected from the group consisting of rear, front, and side.

20. The method of claim 16 and further comprising:
applying a reflective tape.
